(19) United States
(12) Patent Application Publication
(10) Pub. No.: US 2014/0195900 A1
(43) Pub. Date: Jul. 10, 2014

(54) COMPUTER READABLE MEDIUM FOR ENHANCED DISPLAY OF DIGITAL TEXT

(71) Applicant: Gregory B. GABEL, Sherman Oaks, CA (US)

(72) Inventor: Gregory B. GABEL, Sherman Oaks, CA (US)

(21) Appl. No.: 14/134,986

(22) Filed: Dec. 19, 2013

Related U.S. Application Data
(60) Provisional application No. 61/740,309, filed on Dec. 20, 2012.

(51) Int. Cl. G06F 17/24; G06F 17/21

(52) U.S. Cl. CPC G06F 17/24; G06F 17/211
USPC 715/256

(57) ABSTRACT

A software application that acquires digital text displayed on an electronic device with a digital display and enhances the digital text, thereby reducing eye strain and increasing readability and reading speed. The software may operate concurrently with digital text being displayed as an overlaid window of enhanced text that is magnified and scrolls continuously. Parameters of the magnified scrolling text may be adjusted to increase or decrease text volume, quantity, scrolling speed, and magnification factor.

### CROSS-REFERENCE TO RELATED APPLICATION

This present application claims the benefit of Provisional Application No. 61/740,309 filed Dec. 20, 2012.

### FEDERALLY SPONSORED RESEARCH: Not Applicable

### SEQUENCE LISTING OR PROGRAM: Not Applicable

### BACKGROUND

The use of electronic devices to display digital text is increasingly replacing written text. The emergence of digital text has been applied to an extensive range of devices, including personal computers, tablets, mobile phones, and many other consumer electronics. The digital text format is being applied to simple transfers of information, such as browsing the Internet or reading a book on a mobile device, to more complicated information, such as flight plans used by airplane pilots.

As electronic devices and their display screen become smaller in size, the digital text being displayed is likewise becoming smaller and more difficult to read. Moreover, electronic devices do not allow the reader to continuously magnify or enhance a small portion of text while reading, the reader must instead magnify a portion of text, read that portion of text, then select a subsequent portion of text to magnify. Further, the reader is often unable to control the volume of text that is magnified or enhanced. These shortcomings cause eye fatigue, squinting of the eyes, excessive focusing and re-focusing, confusion for the reader, and many other readability problems.

For the foregoing reasons, it would be desirable to have software that can enhance the display of digital text while reducing eye fatigue and increasing reading speed by magnifying a segment of text and continuously scrolling additional text across an overlaid window as the user is reading. The solution is found in the present disclosure that comprises software as a non-transitory computer readable medium to magnify a segment of digital text and continuously scroll additional text as the user reads while providing additional parameters to enhance readability, such as text quantity, magnification factor, and scroll speed.

### SUMMARY

The present disclosure is directed to an software for enhancing the display of digital text that satisfies the need to reduce eye strain and fatigue caused by reading digital text by magnifying a segment of text and continuously scrolling additional text across an overlaid window as the user is reading. The software further enhances the ease and speed at which a user can read digitally displayed text by providing additional control over scrolling speed, text volume, and the magnification factor.

The software for enhancing the display of digital text reduces the reader's eye strain while increasing reading speed with the continuous scrolling of enhanced text to the desired speed, volume and magnification factor of a particular reader. Control over scrolling speed allows the reader to set a pace that is their natural reading speed. Control over the volume of text being displayed in the window reduces eye strain by allowing the reader to focus only on a portion of the text. Control over the magnification factor allows the reader to set the size of the text that is appropriate for their vision quality.

### DRAWINGS

FIG. 1A illustrates a visual depiction of a singe-line window format displayed on an electronic device for software for enhancing the display of digital text.

FIG. 1B illustrates a visual depiction of a chunk window format displayed on an electronic device for software for enhancing the display of digital text.

FIG. 2 is a block diagram illustrating the overview of major steps for software for enhancing the display of digital text.

FIG. 3 is a block diagram illustrating steps for using software for enhancing the display of digital text.

FIG. 4 illustrates an alternative visual depiction of a singe-line window format displayed on an electronic device for software for enhancing the display of digital text.

### DESCRIPTION

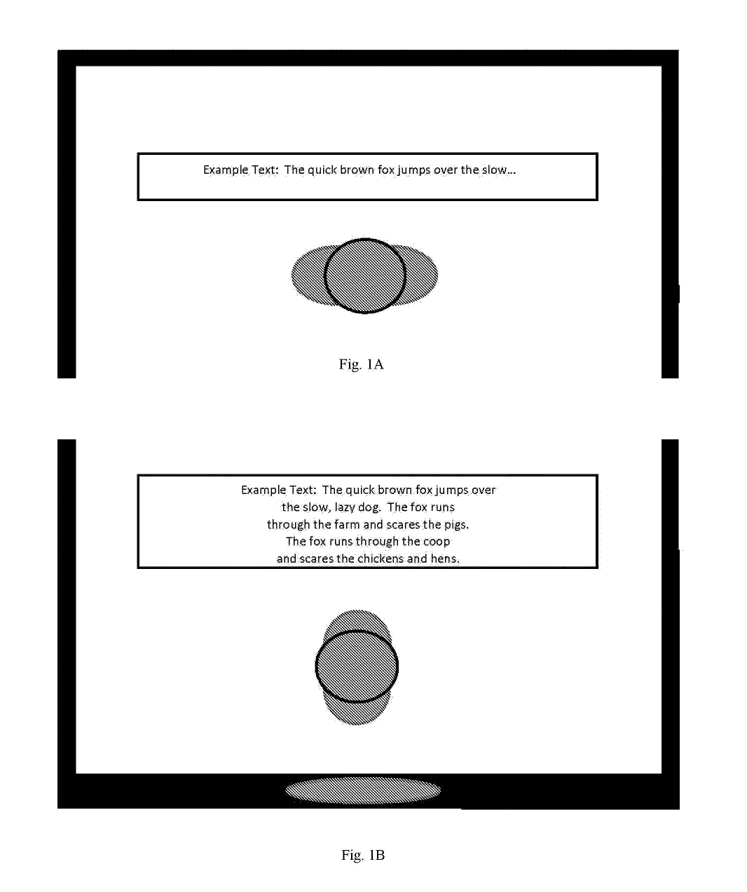

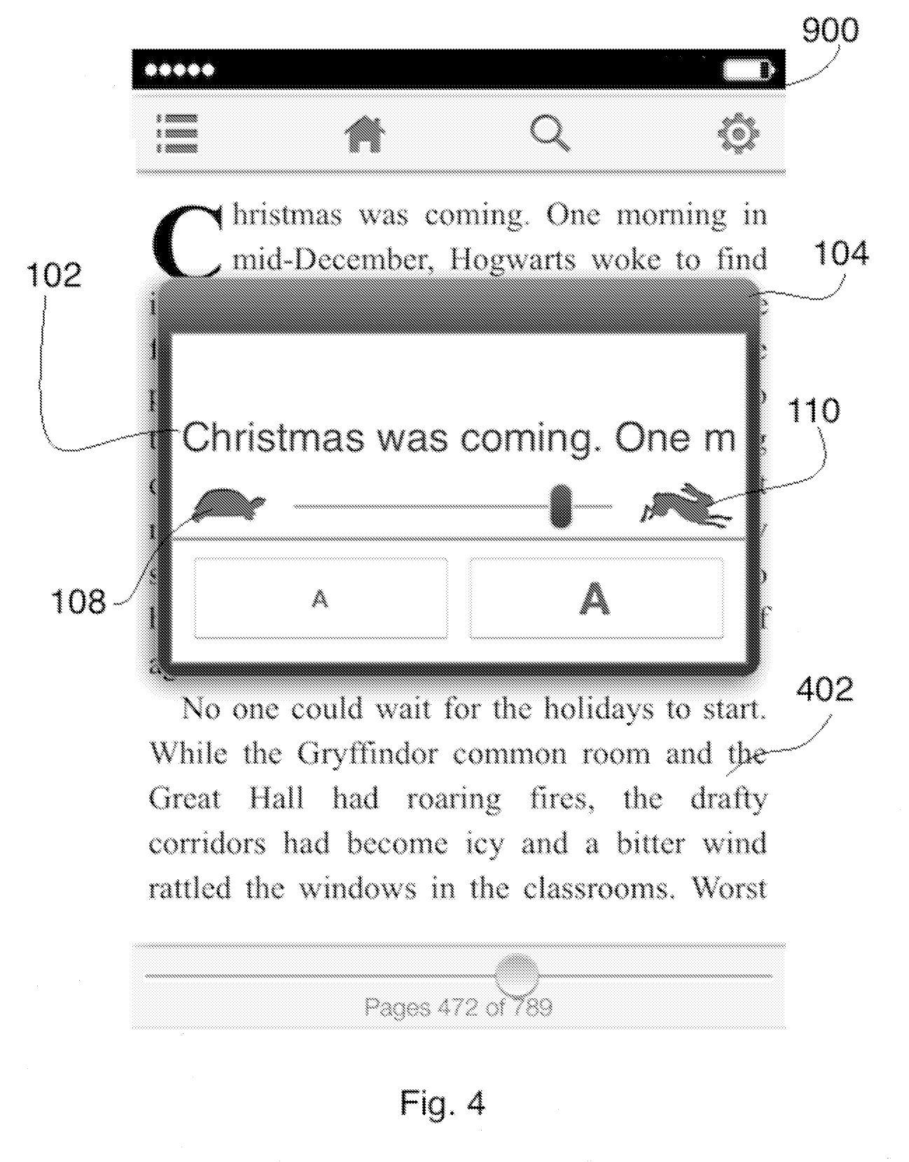

As shown in FIGS. 1-4 software for enhancing the display of digital text is implemented using non-transitory computer readable medium in an electronic device having a digital screen 900, such as a personal computer, a tablet, a mobile phone, or any other electronic device capable of displaying text. As illustrated in FIG. 1A-1B and 4, the software may display text that has been magnified in a window overlaid onto the content 402 being displayed on the digital screen 900. The volume of text, or quantity of words, to be displayed in the window is variable and may be a single line of text, “Single-line Window Mode” 102, or multiple lines of text, “Chunk Window Mode” 103. Adjustable parameters may further include the ability to adjust scrolling speed using on-screen buttons, i.e. slower 108 or faster 110. On-screen buttons also allow the user to start or stop 106 scrolling of the text. The overlaid window size may be adjusted using the window's borders 104, resulting in an increase or decrease of the text magnification factor. In alternative embodiment, features that allow the reader to rewind a set number of words, lines, or paragraphs may also be incorporated.

One of skill in the art will recognize that the present disclosure may be implemented as one or more software processes executable by one or more processors and/or one or more firmware applications. Additionally, the present invention is not described with reference to any particular programming language. It will be appreciated that a variety of programming languages may be used to implement the teachings of the invention as described herein. It is also to be understood that the methods may be employed with any form of memory device including all forms of sequential, pseudo-random, and random access storage devices. Storage devices as known within the current art include all forms of random access memory, magnetic and optical tape, magnetic and optical disks, along with various other forms of solid-state mass storage devices. The current invention applies to all forms and manners of memory devices including, but not limited to, storage devices utilizing magnetic, optical, and chemical techniques, or any combination thereof.

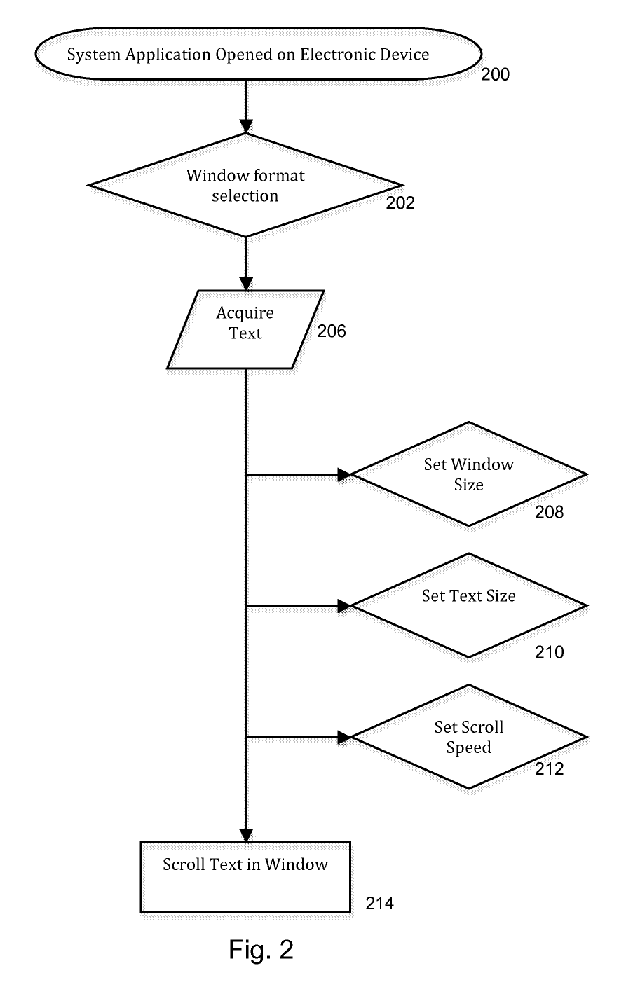

FIG. 2 illustrates steps that may be used to implement software for enhancing the display of digital text. When a user reads a webpage, document, or other form of digital text 402, they may initiate the software 200. Once the software is started on an electronic device 200, the user may be prompted to select a window format for the volume of text 202, for example Single-line Window Mode 102 or Chunk Window Mode 103 may be selected. Next, text that is presently displayed on the electronic device digital screen 900 is acquired and a segment of text is magnified and displayed in the overlaid window according to the window format selection 202. The window size is then set 208, the text size 210 is set according in relation to the window format selection 202, and the scroll speed is set 212. Finally, the text may then scroll within the window 214.

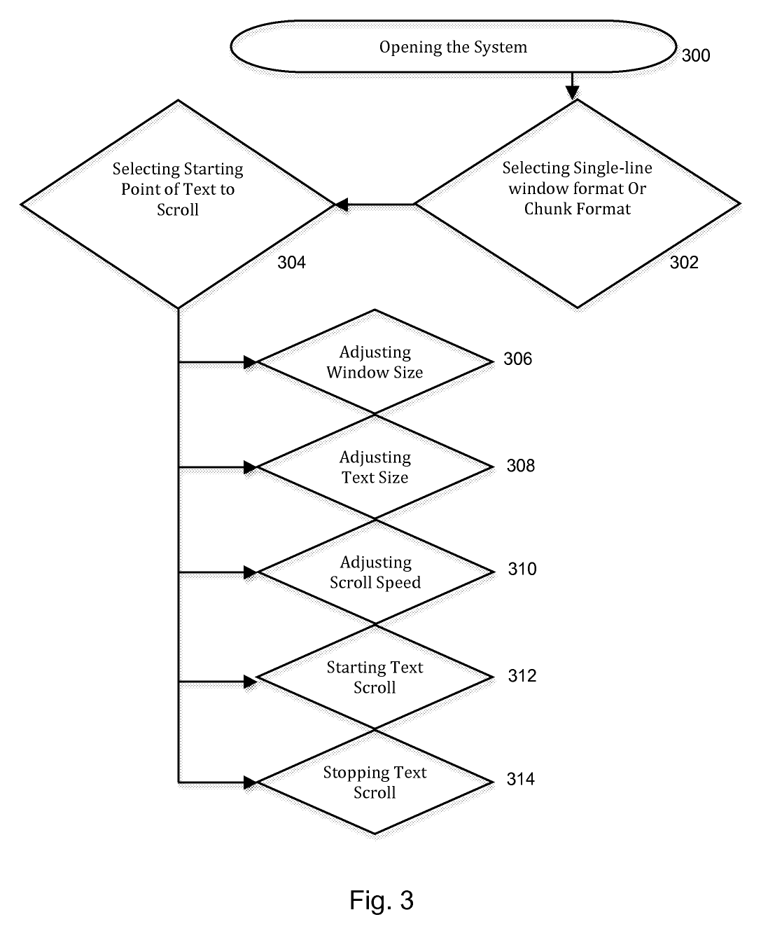

FIG. 3 illustrates how the software for enhancing the display of digital text may be used on by a reader. In a preferred embodiment, the reader has a webpage, document, or other form of digital text 402 on their electronic device digital screen 900. Next, they open an application to initiate the software for enhancing the display of digital text 300. Next, the reader may select the volume of enhanced text in the overlaid window 302, either Single-line Window Mode 102 or Chunk Window Mode 103. Optionally, the user may preset the desired volume of enhanced text to use each time the software is initiated 300. Next, the user may select where the software should begin to enhance text within the body of text 304 currently displayed, otherwise the software may begin at the first instance of text in webpage, document, or other form of digital text. Next, the overlaid window size may be adjusted 306 by pressing or sliding the borders of the window. The enhanced text size may be adjusted 308 manually by the reader, or the software may adjust the text size to maximize space in overlaid window size. The speed at which the text scrolls may be adjusted 310 faster or slower at any time by the user, however a present speed may be used by default. Finally, the reader may start the text scrolling 312 to begin reading and stop the text scrolling 314 at any time.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed:

1. A non-transitory computer readable medium for enhancing the display of digital text viewed upon a electronic device comprising a computer and a digital display, said non-transitory computer readable medium causing the computer to execute the following procedure:
i. opening a window on the digital display, the window being overlaid upon text shown on the digital display,
ii. displaying a segment of text within the overlaid window,
iii. adjusting the size of the overlaid window,
iv. adjusting the text size within the overlaid window,
v. continuously scrolling the remaining text across the overlaid window,
vi. adjusting the speed at which the text scrolls in the overlaid window, and
vii. stopping text scrolling in the overlaid window.

2. The non-transitory computer readable medium of 1, wherein segment of text displayed within overlaid window is at least one line of text.

3. The non-transitory computer readable medium of claim 1, wherein the text size is adjusted by changing size of the overlaid window.

4. The non-transitory computer readable medium of claim 1, wherein the size of the overlaid window is adjusted by dragging borders on the overlaid window.
